(19) United States
(12) Patent Application Publication
(10) Pub. No.: US 2024/0209863 A1
(43) Pub. Date: Jun. 27, 2024

(54) ELECTRIC BLOWER AND CLEANING APPARATUS

(71) Applicant: GUANGDONG WELLING MOTOR MANUFACTURING CO., LTD., Foshan (CN)

(72) Inventors: Meijian XIONG, Foshan (CN); Zhengzhong QIAO, Foshan (CN)

(73) Assignee: GUANGDONG WELLING MOTOR MANUFACTURING CO., LTD., Foshan (CN)

(21) Appl. No.: 18/595,953

(22) Filed: Mar. 5, 2024

Related U.S. Application Data
(63) Continuation of application No. PCT/CN2022/079374, filed on Mar. 4, 2022.

(30) Foreign Application Priority Data
Sep. 6, 2021 (CN) 202111040382.7
Sep. 6, 2021 (CN) 202122146220.3

(51) Int. Cl. F04D 25/06; A47L 5/24; A47L 9/22; F04D 29/28; F04D 29/44

(52) U.S. Cl. CPC F04D 25/06; A47L 5/24; A47L 9/22; F04D 29/281; F04D 29/444

(57) ABSTRACT

An electric blower and a cleaning apparatus are provided. The electric blower includes a shell assembly, a wind cover, a rotary impeller and a diffuser. A stator assembly and a rotor assembly are provided inside the shell assembly. The wind cover is connected to the shell assembly. The rotary impeller is located inside the wind cover, and is connected to a rotating shaft of the rotor assembly. The diffuser is arranged at the end of the shell assembly, which faces the wind cover, and is located between the rotary impeller and the shell assembly. An outer wall of the shell assembly is provided with a cylindrical portion. Multiple circumferentially distributed mounting support legs are provided at the end of the cylindrical portion, which faces away from the wind cover. The mounting legs are used to fit with an assembly structure of a cleaning apparatus.

### CROSS-REFERENCE TO RELATED APPLICATIONS

This application is a continuation of International Application No. PCT/CN2022/079374 filed on Mar. 4, 2022, which claims priority to and benefits of Chinese Patent Application No. 202111040382.7 filed on Sep. 6, 2021 and Chinese Patent Application No. 202122146220.3 filed on Sep. 6, 2021, the entire contents of each of which are incorporated herein by reference for all purposes. No new matter has been introduced.

### FIELD

The present disclosure relates to the field of electric blowers, and in particular to an electric blower and a cleaning apparatus.

### BACKGROUND

In the related art, electric blowers in hand-held vacuum cleaners have the advantages of small size and high rotating speed. When the motor of the electric blower drives the impeller to rotate, a vacuum is formed at the entrance of the wind cover, and the airflow is sucked in through the opening of the wind cover and then flows out through the diffuser at the downstream after obtaining large kinetic energy through the flow channel of the impeller. However, the structure for mounting of the electric blower in the hand-held vacuum cleaner is complex and is not conducive to assembly and maintenance.

### SUMMARY

The present disclosure aims to resolve at least one of the technical problems in the related art. To this end, the present disclosure provides an electric blower suitable for being mounting into a cleaning apparatus, to reduce the assembly difficulty and facilitate maintenance.

The present disclosure also provides a cleaning apparatus using the electric blower.

According to a first aspect of the present disclosure, an embodiment provides an electric blower, applicable to a cleaning apparatus. The electric blower includes a shell assembly, a wind cover, a rotary impeller, and a diffuser. A stator assembly and a rotor assembly are arranged inside the shell assembly, the wind cover is connected to the shell assembly, the rotary impeller is located inside the wind cover and is connected to a rotating shaft of the rotor assembly, the diffuser is arranged at an end of the shell assembly facing the wind cover, the diffuser is located between the rotary impeller and the shell assembly; a cylindrical portion is arranged on an outer wall of the shell assembly, a plurality of mounting legs are circumferentially distributed at an end of the cylindrical portion facing away from the wind cover, and the mounting legs are configured to fit with an assembly structure of the cleaning apparatus.

The electric blower according to embodiment of the first aspect of the present disclosure has the following beneficial effects. The rotor assembly drives the rotary impeller to rotate at a high speed. The rotary impeller and the wind cover cooperate to generate a high-speed airflow. The high-speed airflow passes through the diffuser for diffusion, so as to generate a large suction force and meet usage requirements of the cleaning apparatus. The shell assembly is provided with a plurality of mounting legs. The mounting legs can fit with the assembly structure of the cleaning apparatus, to facilitate the mounting of the electric blower into the cleaning apparatus, thereby simplifying the structure and shortening the assembly time.

According to some embodiments of the first aspect of the present disclosure, in a radial direction of the shell assembly, the mounting legs protrude out of an outer wall of the cylindrical portion.

According to some embodiments of the first aspect of the present disclosure, in an axial direction of the shell assembly, a connecting portion is arranged at a root of each of the mounting legs connected to the cylindrical portion, and the connecting portion extends to the wind cover and is connected to the outer wall of the cylindrical portion.

According to some embodiments of the first aspect of the present disclosure, the cylindrical portion and the mounting leg are an integrally formed structure.

According to some embodiments of the first aspect of the present disclosure, the cylindrical portion and the mounting legs are formed in an integral plastic or metal member.

According to some embodiments of the first aspect of the present disclosure, the electric blower further includes a control board. A stepped surface is provided on an inner side surface of each of the mounting legs facing a center of the shell assembly, the control board abuts against the stepped surface, and the control board is fixedly connected to the mounting legs by fasteners.

According to a second aspect of the present disclosure, an embodiment provides a cleaning apparatus, including the electric blower according to the embodiments of the first aspect.

According to some embodiments of the second aspect of the present disclosure, the cleaning apparatus further includes a mounting sleeve. The electric blower is arranged in an inner cavity of the mounting sleeve, an end of the mounting sleeve wraps an outer wall of the wind cover, a plurality of exhaust holes are provided in a peripheral wall at another end of the mounting sleeve, mounting pads are arranged inside the mounting sleeve, and each of the mounting pads is provided with an insertion hole to match with a corresponding mounting leg.

According to some embodiments of the second aspect of the present disclosure, the mounting sleeve consists of two halve, and the two sleeve halves are removably connected in an axial direction of the electric blower.

According to some embodiments of the second aspect of the present disclosure, a flexible cover is arranged on an inner wall of the mounting sleeve, and the flexible cover surrounds the wind cover and abuts against the outer wall of the wind cover.

The additional aspects and advantages of the present disclosure will be provided in the following description, some of which will become apparent from the following description or may be learned from practices of the present disclosure.

### BRIEF DESCRIPTION OF DRAWINGS

The foregoing and/or additional aspects and advantages of the present disclosure will become apparent and comprehensible from the following descriptions of the embodiments in conjunction with the accompanying drawings, where:

FIG. 1 is a sectional view of an electric blower according to some embodiments of a first aspect of the present disclosure;

FIG. 2 is a sectional view showing a rotary impeller and a stationary impeller in a fit connection according to an embodiment of the present disclosure;

FIG. 3 is a sectional view of the stationary impeller according to an embodiment of the present disclosure;

FIG. 4 is a schematic structural view of the stationary impeller using axial blades according to an embodiment of the present disclosure;

FIG. 5 is a schematic structural view of the stationary impeller using radial blades according to an embodiment of the present disclosure;

FIG. 6 is a schematic structural view of the rotary impeller according to an embodiment of the present disclosure;

FIG. 7 is a schematic structural view of a shell assembly from a top perspective view according to an embodiment of the present disclosure;

FIG. 8 is a first schematic structural view of the shell assembly connected to the stationary impeller according to an embodiment of the present disclosure;

FIG. 9 is a schematic structural view of FIG. 8 with diffuser blades being concealed by the stationary impeller;

FIG. 10 is a second schematic structural view of the shell assembly connected to the stationary impeller according to an embodiment of the present disclosure;

FIG. 11 is a schematic structural view of FIG. 10 with diffuser blades being concealed by the stationary impeller;

FIG. 12 is a top view of the shell assembly connected to the stationary impeller according to an embodiment of the present disclosure;

FIG. 13 is an exploded view of the shell assembly and the stationary impeller according to an embodiment of the present disclosure;

FIG. 14 is a sectional view of the shell assembly and a stator assembly according to an embodiment of the present disclosure;

FIG. 15 is a sectional view of the shell assembly and the stator assembly according to another embodiment of the present disclosure;

FIG. 16 is a schematic structural view of the shell assembly from a bottom perspective view according to an embodiment of the present disclosure;

FIG. 17 is a bottom view of the shell assembly according to an embodiment of the present disclosure;

FIG. 18 is a schematic exploded view of the shell assembly and the stator assembly from a bottom perspective view according to an embodiment of the present disclosure;

FIG. 19 is a schematic structural view of the shell assembly and the stator assembly from a bottom perspective view according to an embodiment of the present disclosure;

FIG. 20 is a schematic structural view of the electric blower from a bottom perspective view according to an embodiment of the present disclosure;

FIG. 21 is a sectional view of the electric blower according to some other embodiments of the first aspect of the present disclosure;

FIG. 22 is a front view of the shell assembly according to an embodiment of the present disclosure;

FIG. 23 is a schematic structural view of a mounting pad according to an embodiment of a second aspect of the present disclosure;

FIG. 24 is a schematic structural view of a mounting sleeve according to an embodiment of the second aspect of the present disclosure; p FIG. 25 is a sectional view of a mounting sleeve and an electric blower according to an embodiment of the second aspect of the present disclosure; and

FIG. 26 is a schematic structural view of a cleaning apparatus according to an embodiment of the second aspect of the present disclosure.

### LIST OF REFERENCE NUMERALS

shell assembly 100, diffusing channel 101, secondary diffusing channel 102, blade clamping groove 103, cylindrical portion 110, stator mounting portion 120, mounting groove 121, first end face 122, ventilation groove 123, inner cylinder 124, secondary diffuser blade 130, rotor mounting portion 140, reinforcing rib 141, threaded hole 142, clamping groove 143, mounting leg 150, connecting portion 151, stepped surface 152;

stator assembly 200, fluid channel 201, stator core 210, first end 211, winding 220, mounting portion 230, wiring terminal 240;

rotor assembly 300, rotating shaft 310;

stationary impeller ordiffuser 400, groove 401, through hole 402, diffuser blade 410, side plate 420, second inclined surface 421, sleeve 430, clamping ring 431, inner annular plate 440, mounting cylinder 450, limiting portion 451;

rotary impeller 500, cam ring portion 501, first inclined surface 502, rotary blade 510, shaft sleeve 520, umbrella-shaped cover 530;

wind cover 600, air inlet 601;

control board 700;

hand-held vacuum cleaner 800, cleaning portion 810, caster 811, connecting rod 820, handle 830, mounting sleeve 840, exhaust hole 841, mounting pad 850, insertion hole 851, and flexible cover 860.

### DETAILED DESCRIPTION OF EMBODIMENTS

Embodiments of the present disclosure will be described in detail hereinafter with reference to accompanying drawings in which the same or like reference numerals refer to the same or like elements or elements having the same or like functions. The embodiments described below with reference to the accompanying drawings are illustrative. The embodiments are only used for illustrating the present disclosure, and are not intended to be construed as limiting the present disclosure.

In the description of the present disclosure, it should be understood that for the description of orientations, the orientation or positional relationships indicated by the terms such as “up”, “down”, “front”, “rear”, “left”, and “right” should be construed to refer to the orientation as then described or as shown in the drawings under discussion. These relative terms are merely for convenience of descriptions of the present disclosure and for simplifying descriptions, and do not indicate or imply that the referred apparatus or component should have a specific orientation and be constructed or operated in a particular orientation. Therefore, such terms should not be construed as limiting the present disclosure.

In the description of the present disclosure, the terms such as “first”, “second”, and the like are merely used for distinguishing technical features, and are not intended to indicate or imply relative importance, or implicitly point out the number of the indicated technical features, or implicitly point out the precedence order of the indicated technical features.

In the description of the present disclosure, unless otherwise explicitly defined, the terms such as “arrange”, “install/mount” and “connect” should be understood in a broad sense, and those having ordinary skills in the art can reasonably determine the specific meanings of the above terms in the present disclosure based on the specific contents of the technical scheme. A cleaning apparatus is used for cleaning dust. Vacuum cleaners are the most commonly used cleaning apparatuses. The operating principle of a vacuum cleaner is that the electric blower in the vacuum cleaner operates at a high speed to suck air and dust through the dust suction port, the dust is left in a filter element, and the filtered air is discharged to the outside of the vacuum cleaner.

The electric blower is the core component of the vacuum cleaner, and serves as the power source of the vacuum cleaner. Main components of the electric blower include a blower assembly. The blower assembly further includes a wind cover, a diffuser, and a rotary impeller. The diffuser remains stationary relative to the shell (i.e., the diffuser is fixedly connected to the shell). The rotary impeller rotates at a high speed under the drive of the rotor, and the air in the rotary impeller is thrown out under the centrifugal force, with high radial and tangential speeds. On the one hand, a negative pressure is formed inside the rotary impeller, and air continuously flows from outside to the rotary impeller through the air inlet of the wind cover. On the other hand, the high-speed airflow thrown out by the rotary impeller is diffused by the diffuser blades of the diffuser and finally discharged. With the high-speed rotation of the rotary impeller, the electric blower can continuously suck in air, to meet the functional requirements of the vacuum cleaner.

The diffuser in the electric blower cooperates with the rotary impeller. In the operating state, the rotary impeller rotates to generate airflow, and the airflow from inside passes through the diffuser to outside. When the airflow flows through the diffuser, the flow velocity is reduced, thus converting the kinetic energy of the air into static pressure energy and realizing pressurization. Diffusers can be divided into vaned diffusers and vaneless diffusers. The vaned diffuser is a diffuser with blades, which can limit the flow direction of airflow through the shape and angle of the blades and forces the airflow to flow through a channel of a given geometric shape to achieve a smaller size and smaller flow loss. The diffuser of the present disclosure is a vaned diffuser. The term “diffuser” refers to a vaned diffuser in the following description. The airflow passes through a channel formed between two adjacent blades of the diffuser. The flow velocity of the air is reduced in the process of the air flowing through the channel, to achieve pressurization.

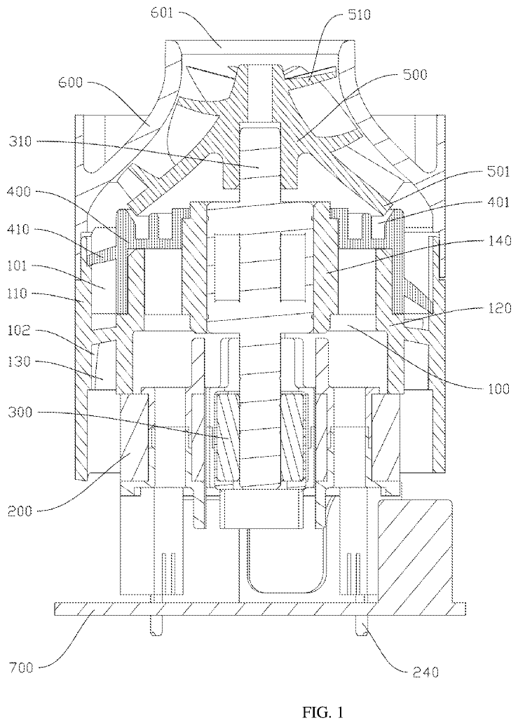

As shown in FIG. 1, an embodiment of a first aspect of the present disclosure provides an electric blower, which includes a shell assembly 100, a stator assembly 200, a rotor assembly 300, a diffuser 400, a rotary impeller 500, a wind cover 600, and a control board 700. The shell assembly 100 is the main body of the electric blower. The stator assembly 200 and the rotor assembly 300 are mounted inside the shell assembly 100. The stator assembly 200 is fixedly mounted on a stator mounting portion 120 of the shell assembly 100. The rotor assembly 300 is rotatable relative to the stator assembly 200. The rotor assembly 300 and the stator assembly 200 constitute a driving mechanism. The wind cover 600 is connected to an end of the shell assembly 100. A wind guide cavity is formed inside the wind cover 600. The wind cover 600 is hermetically connected to an outer wall of the shell assembly 100. The rotary impeller 500 is located in the wind guide cavity of the wind cover 600. A rotating shaft 310 of the rotor assembly 300 is fixedly connected to the rotary impeller 500. The rotor assembly 300 is configured for driving the rotary impeller 500 to rotate. A cylindrical portion 110 is arranged on the outer wall of the shell assembly 100. The stator mounting portion 120 is arranged inside the shell assembly 100. A diffusing channel 101 is formed between the cylindrical portion 110 and the stator mounting portion 120. The diffusing channel 101 is annular. The diffusing channel 101 is communicated with the air guide cavity. The diffuser 400 is mounted on the stator mounting portion 120. The diffuser 400 includes a plurality of diffuser blades 410 located in the diffusing channel. The shell assembly 100 may further be provided with a secondary diffusing channel 102 downstream of the diffusing channel 101, and secondary diffuser blades 130 are arranged in the secondary diffusing channel 102. The control board 700 is connected to an end of the shell assembly 100 facing away from the wind cover 600. The control board 700 is electrically connected to the stator assembly 200 to control operation of the driving mechanism.

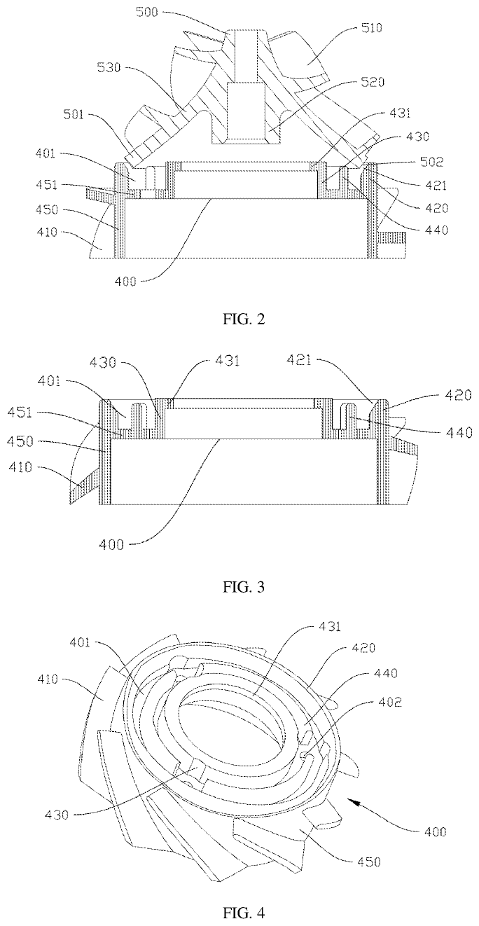

Referring to FIG. 2 to FIG. 6, it can be understood that an end of the diffuser 400 facing the rotary impeller 500 is defined as an outer end. A groove 401 is formed on the outer end. A cam ring portion 501 is provided on an end of the rotary impeller 500 facing the diffuser 400. The cam ring portion 501 matches the groove 401. The cam ring portion 501 is annular and extends to the interior of the groove 401. In an axial direction of the rotary impeller 500, the diffuser 400 and the cam ring portion 501 are partially staggered from each other, such that the diffuser 400 and the cam ring portion 501 provide a dual-blocking effect to reduce air leakage. In addition, the cam ring portion 501 and an inner wall of the groove 401 form a curved channel which can increase the flow resistance to reduce the volume of air leakage.

As shown in FIG. 2, when the electric blower operates, the rotor assembly 300 drives the rotary impeller 500 to rotate at a high speed. The rotary impeller 500 and the wind cover 600 cooperate to generate a high-speed airflow. The high-speed airflow flows into the diffusing channel 101. Under the action of the diffuser blades 410 of the diffuser 400, the flow velocity of the airflow is reduced and the pressure is increased. Because the cam ring portion 501 of the rotary impeller 500 extends into the groove 401 on the diffuser 400, interlaced barriers are formed in the axial direction of the rotary impeller 500, which greatly reduce the leakage of high-speed airflow from the gap between the diffuser 400 and the rotary impeller 500, thereby reducing air leakage and improving the performance of the electric blower.

Referring to FIG. 3, it can be understood that a side plate 420 is arranged at the outer end of the diffuser 400. In order to avoid colliding with other portions during rotation, since the rotary impeller 500 needs to rotate at a high speed and the cam ring portion 501 is annular, the side plate 420 also needs to be configured as an annular structure. The cam ring portion 501 and the side plate 420 are arranged concentrically, to further reduce the distance between the cam ring portion 501 and the side plate 420, thereby reducing the volume of air leakage. The side plate 420 may be arranged in the middle of the outer end or at an edge of the outer end. For example, the side plate 420 is arranged at the edge of the outer end. In this case, the side plate 420 is close to the diffusing channel 101, and can restrain the lateral diffusion of the airflow. It can be understood that the groove 401 is located inside the side plate 420, the cam ring portion 501 extends into the groove 401, and the side plate 420 and the cam ring portion 501 are interlaced with each other in the axial direction of the rotary impeller 500, providing an air blocking function to reduce air leakage.

It can be understood that the groove 401 may be circular, i.e., an entirety of space inside the side plate 420 forms the groove 401, and the cam ring portion 501 can extend into the groove 401 without affecting the rotation of the rotary impeller 500. Alternatively, the groove 401 may be annular, a sleeve 430 is further arranged at the outer end of the diffuser 400 on an inner side of the side plate 420, and the annular groove 401 is formed between the sleeve 430 and the side plate 420. The sleeve 430 also has a function of increasing the flow resistance to reduce the volume of air leakage.

Referring to FIG. 3 and FIG. 4, it can be understood that an inner annular plate 440 is further arranged at the outer end. The inner annular plate 440 is located between the sleeve 430 and the side plate 420. The inner annular plate 440 and the side plate 420 are distributed on two sides of the cam ring portion 501, forming a labyrinth structure. The leaked air has to continuously bypass the side plate 420, the cam ring portion 501, and the inner annular plate 440, and experiences high flow resistance, so that the volume of air leakage can be reduced. In addition, the inner annular plate 440 also serves to increase the strength and improve the structural stability of the diffuser 400. As shown in FIG. 1, the inner annular plate 440 extends toward the rotary impeller 500, a small gap is formed between the inner annular plate 440 and the rotary impeller 500, and a flow direction of the leaked airflow is opposite to the flow direction driven by the rotary impeller 500, thereby further reducing air leakage.

Referring to FIG. 2, it can be understood that a smaller distance between the cam ring portion 501 and the side plate 420 is more favorable to reduce air leakage. Opposing surfaces of the cam ring portion 501 has a surface configured as a first inclined surface 502, which is opposite to a surface of the side plate 420, which is defined as a second inclined surface 421, both of which are arranged obliquely to form an acute angle with an axis of the rotary impeller 500. The angle between the first inclined surface 502 and the axis of the rotary impeller 500 can be 40°. The second inclined surface 421 may be parallel to the first inclined surface 502 or not. An angle between the second inclined surface 421 and the first inclined surface 502 is controlled to be in a range of 0-10°. The first inclined surface 502 and the second inclined surface 421 have a relatively narrow gap therebetween and provide a long flow channel, helping reduce the amount of leakage. In addition, when the rotary impeller 500 rotates at a high speed, the first inclined surface 502 and the second inclined surface 421 are less likely to interfere with each other, thereby facilitating stable operation of the rotary impeller 500.

Referring to FIG. 1, it can be understood that a rotor mounting portion 140 for mounting the rotor assembly 300 is arranged in a center of the shell assembly 100, the diffuser 400 is mounted on the rotor mounting portion 140 through the sleeve 430, and the sleeve 430 is connected to an outer wall of the rotor mounting portion 140. The outer wall of the rotor mounting portion 140 is a cylindrical surface, and the sleeve 430 fits with the cylindrical surface. As shown in FIG. 4 and FIG. 7, the diffuser 400 is provided with through holes 402, and a plurality of reinforcing ribs 141 are circumferentially evenly distributed between the rotor mounting portion 140 and the stator mounting portion 120. Some of the reinforcing ribs 141 are provided with a threaded hole 142 for fitting with the through holes 402. The diffuser 400 can be fixed by connecting screws to the threaded holes 142 through the through holes 402. The inner annular plate 440 is provided with notches to evade the screws. Alternatively, the sleeve 430 may be in interference fit with the rotor mounting portion 140 to fix the diffuser 400.

Referring to FIG. 1, it can be understood that considering the need for axial positioning the diffuser 400 when assembling, a clamping ring 431 is arranged on an inner wall of the sleeve 430, and a clamping groove 143 for engaging with the clamping ring 431 is provided on an outer wall of an end of the rotor mounting portion 140. The clamping ring 431 is engaged into the clamping groove 143 to realize axial positioning of the diffuser 400, facilitating the assembly and improving the efficiency. Moreover, the clamping ring 431 fits to an inner wall of the clamping groove 143 to form a gap with multiple bending sections, to prevent air leakage.

Referring to FIG. 2 and FIG. 6, it can be understood that a shaft sleeve 520 is arranged in a center of the rotary impeller 500. The shaft sleeve 520 is configured for connecting to the rotating shaft 310 of the rotor assembly 300. An umbrella-shaped cover 530 is arranged on an outer periphery of the rotary impeller 500. A plurality of rotary blades 510 are arranged on an outer wall of the umbrella-shaped cover 530. The rotary impeller 500 is an integral structure. The cam ring portion 501 is arranged at an end of the umbrella-shaped cover 530. The umbrella-shaped cover 530 as a whole provides functions of preventing air leakage and guiding the airflow during rotation. The shape of the wind cover 600 is similar to that of the umbrella-shaped cover 530. The wind cover 600 covers the rotary impeller 500 and is provided with an air inlet 601 for sucking in air.

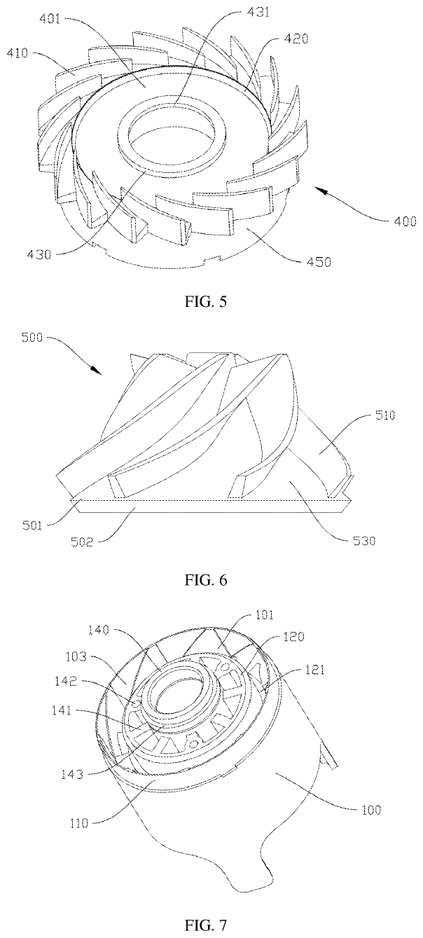

Referring to FIG. 4, it can be understood that the diffuser blades of the diffuser 400 are axial blades. Alternatively, referring to FIG. 5, the diffuser blades are radial blades. Both the axial and radial blades can achieve the effects of reducing the flow velocity of air and increasing the pressure.

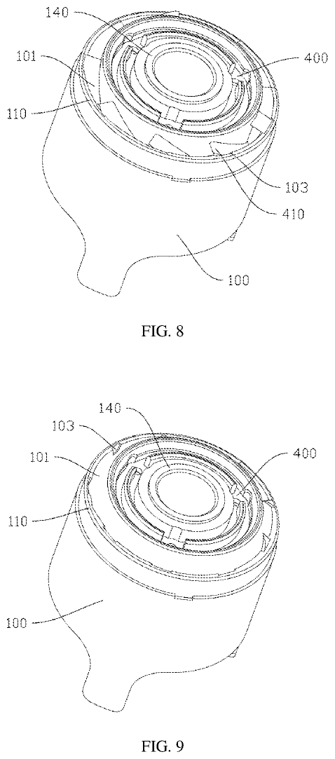

Referring to FIG. 1, in the electric blower according to some embodiments of the first aspect of the present disclosure, two side walls of the diffusing channel 101 are each defined as an inner side wall and an outer side wall, and the plurality of diffuser blades 410 of the diffuser 400 are partially arranged inside the diffusing channel 101. As shown in FIG. 12, in a radial direction of the shell assembly 100, a width dimension of the diffusing channel 101 is defined as S1, a width dimension of the diffuser blade 410 is defined as S2, and S2>S1, i.e., the diffuser blade 410 has a greater width than the diffusing channel 101. As shown in FIG. 8 and FIG. 9, the diffuser 400 is mounted outside the stator mounting portion 120, and an outer wall of the diffuser 400 is the inner side wall of the diffusing channel 101. Blade clamping grooves 103 are provided on the outer side wall of the diffusing channel 101. The outer side wall is arranged at the cylindrical portion 110. During the assembly of the diffuser 400, outer ends of the diffuser blades 410 are clamped into the blade clamping grooves 103, and the blade clamping grooves 103 provide sufficient space to accommodate the diffuser blades 410, so that the shape of the diffuser blades 410 is not affected, and a stable and reliable diffusing effect is achieved.

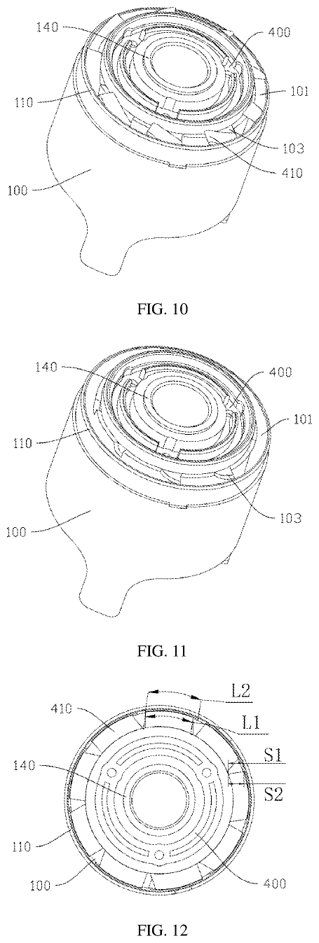

It can be understood that as shown in FIG. 10 and FIG. 11, alternatively, the diffuser blades 410 may be connected to the outer side wall of the diffusing channel 101, and the blade clamping grooves 103 are provided on the inner side wall of the diffusing channel 101. Similarly, during the assembly of the diffuser 400, inner ends of the diffuser blades 410 are clamped into the blade clamping grooves 103, and the blade clamping grooves 103 provide sufficient space to accommodate the diffuser blades 410, so that the shape of the diffuser blades 410 is not affected, and a stable and reliable diffusing effect is achieved.

After the diffuser blades 410 extend into the blade clamping grooves 103, the spacing between the diffuser blades 410 and wall surfaces of the blade clamping grooves 103 is eliminated, thereby substantially eliminating air leakage and improving the diffusing performance. The arrangement of the blade clamping grooves 103 for accommodation lowers the precision requirements on the shape and dimensions of the diffuser blades 410, thereby reducing the production costs. The curved gap formed between the diffuser blades 410 and the inner walls of the blade clamping grooves 103 provides a high flow resistance to reduce air leakage.

Referring to FIG. 1, it can be understood that a mounting cylinder 450 is arranged on the diffuser 400. The mounting cylinder 450 is sleeved on the stator mounting portion 120. A mounting groove 121 for accommodating the mounting cylinder 450 is provided on a peripheral wall of the stator mounting portion 120. A step is formed at a root of the mounting groove 121 to support the mounting cylinder 450. In the radial direction of the shell assembly 100, a depth dimension of the mounting groove 121 is equal to a thickness dimension of the mounting cylinder 450. After the diffuser 400 is assembled, an outer wall of the mounting cylinder 450 is kept flush with the peripheral wall of the stator mounting portion 120, i.e., the inner side wall of the diffusing channel 101 is flat, facilitating the flow of air and reducing the resistance.

Referring to FIG. 1, it can be understood that the mounting cylinder 450 is provided with a limiting portion 451 on a side surface thereof facing the stator mounting portion 120. During the assembly of the diffuser 400, the limiting portion 451 abuts against the stator mounting portion 120 to achieve axial positioning, thereby improving the accuracy and speed of assembly and improving the efficiency.

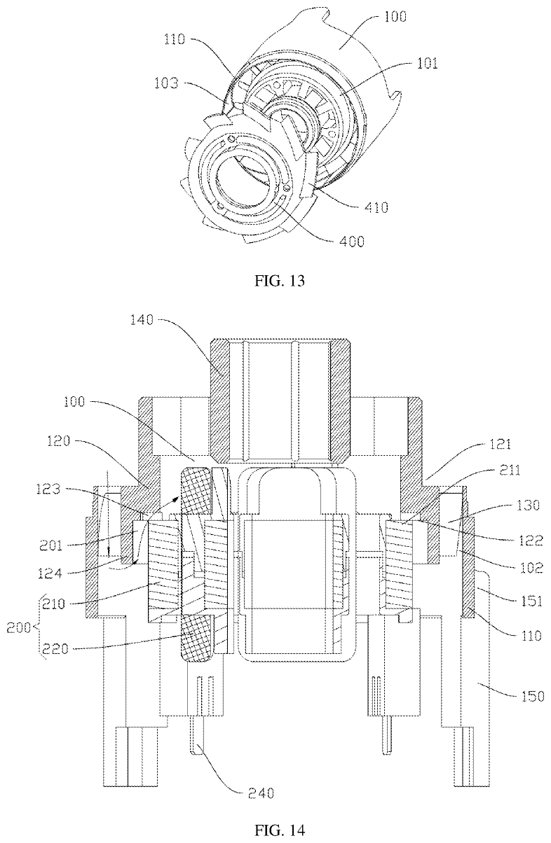

Referring to FIG. 12, it can be understood that on a cross section of the shell assembly 100, the blade clamping grooves 103 have a projection area larger than or equal to a projection area of the diffuser blades 410, to facilitate the insertion of the diffuser blades 410 into the blade clamping grooves 103. In other words, assuming that along a circumferential direction of the diffusing channel 101, a length of an arc occupied by the projection area of the diffuser blade 410 is defined as L1 and a length of an arc occupied by the projection of the blade clamping groove 103 is defined as L2, L2≥L1, as shown in FIG. 13. When the diffuser 400 is fitted to the shell assembly 100, the diffuser blades 410 are in one-to-one correspondence with the blade clamping grooves 103. Each of the blade clamping grooves 103 is sufficient to accommodate a corresponding diffuser blade 410 to avoid interference which results in deformation of the diffuser blade 410.

It can be understood that a smaller gap between the diffuser blade 410 and the inner wall of the blade clamping groove 103 indicates a smaller volume of air leakage. The blade clamping groove 103 is designed to match the shape of the diffuser blade 410, to narrow the gap as much as possible, thereby reducing air leakage.

It can be understood that because the diffuser blades 410 are fixed and do not need to be rotated or moved during the operation of the electric blower, the diffuser blades 410 may be respectively pressed against the inner walls of the blade clamping grooves 103 to better limit the diffuser blades 410 and eliminate the gap to prevent air leakage. In addition, the inner walls of the blade clamping grooves 103 provide support to the respective diffuser blades 410, allowing the diffuser blades 410 to better withstand the pressure of the airflow, thereby reducing deformation and improving the stability.

It can be understood that the inner wall of the blade clamping groove 103 includes a bottom wall and a side wall facing the diffuser blade 410. Each blade clamping groove 103 may be pressed against the corresponding diffuser blade 410 in its entire or part of inner wall.

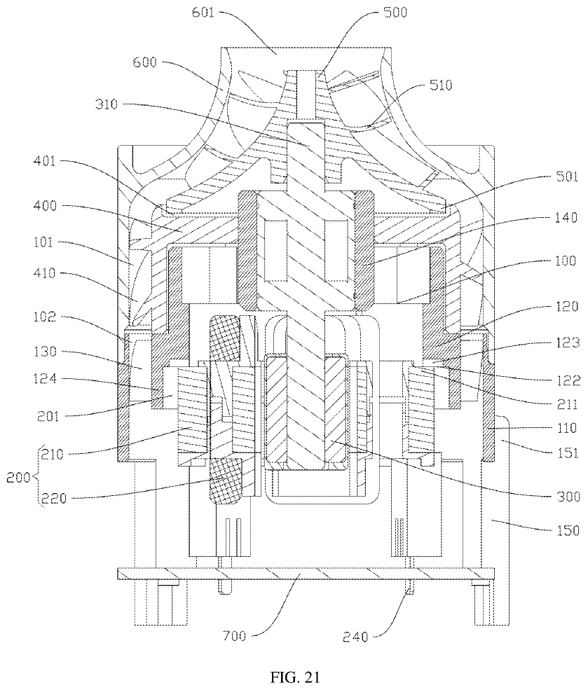

Referring to FIG. 21, in the electric blower according to some embodiments of the first aspect of the present disclosure, the stator assembly 200 generally includes a stator core 210 and a winding 220 wound on the stator core 210. The winding 220 generally protrudes to two axial ends of the stator core 210. The winding 220 generates heat during operation of the electric blower, but the stator assembly 200 mounted inside the shell assembly 100 has unsatisfactory heat dissipation. Therefore, a fluid channel 201 is provided between the stator core 210 and the stator mounting portion 120. An end of the fluid channel 201 is communicated with the diffusing channel 101 and another end of the fluid channel 201 is communicated with the space where the winding 220 is located. The fluid channel 201 facilitates the flow of air to take away heat to cool the winding 220.

It should be understood that for an electric blower having only one diffuser 400, the fluid channel 201 is communicated with the diffusing channel 101; and for an electric blower having two diffusers, the fluid channel 201 is communicated with a secondary diffusing channel 102. The following description is given using an electric blower having two diffusers as an example.

Referring to FIG. 21, when the electric blower operates, a high-speed airflow flows through the secondary diffusing channel 102 and passes through the secondary diffuser blades 130 to reduce the flow velocity and increase the static pressure energy. With the arrangement of the fluid channel 201 between the stator core 210 and the stator mounting portion 120, the high-speed airflow flowing in the secondary diffusing channel 102 drives the air in the fluid channel 201 to flow to take away the heat, helping the winding 220 to dissipate heat, improving the operation stability of the stator assembly 200, and prolonging the service life.

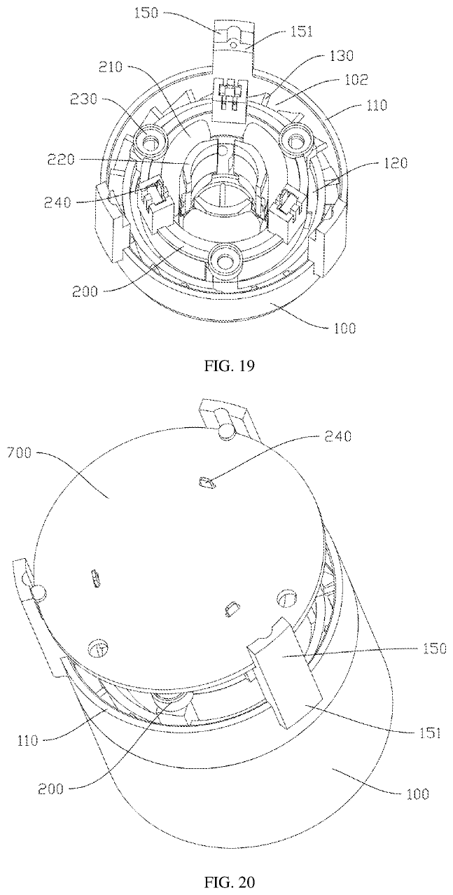

Referring to FIGS. 16 to 19, it can be understood that the stator core 210 has a first end 211 facing the wind cover 600, the stator mounting portion 120 has a first end face 122, the first end 211 abuts against the first end face 122, and a ventilation groove 123 is provided on the first end face 122. The ventilation groove 123 is the fluid channel 201 or the ventilation groove 123 forms a portion of the fluid channel 201. The ventilation groove 123 is communicated with an outer side of the stator core 210 and the space where the winding 220 is located, especially an end of the winding 220 adjacent to the wind cover 600, which end is basically closed and can hardly dissipate heat. The ventilation groove 123 allows for the communication between the inside and the outside. Portion of the airflow in the secondary diffusing channel 102 flows in through the ventilation groove 123 to dissipate heat from the winding 220, or air in the ventilation groove 123 is driven by the airflow in the secondary diffusing channel 102 to dissipate heat from the winding 220 when the air flows, which can both help the winding 220 dissipate heat.

It can be understood that the ventilation groove 123 provides sufficient space for the airflow to pass through. As shown in FIG. 16, in the circumferential direction of the stator core 210, the ventilation groove 123 occupies an arc of at least 30°.

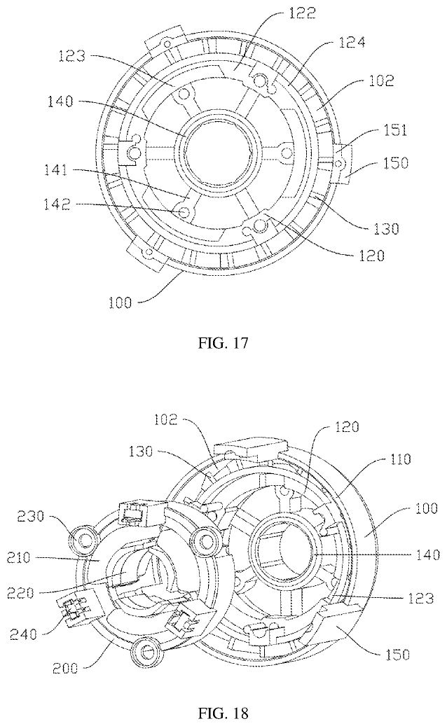

As shown in FIG. 17, three ventilation grooves 123 are provided in the circumferential direction of the stator core 210. A length of an arc occupied by the three ventilation grooves 123 is equal to or greater than half of the circumference of the stator core 210, i.e., an arc of the ventilation grooves 123 on the first end face 122 contacting the stator core 210 is at least 180°, providing a large ventilation area to facilitate the flow of air to dissipate heat from the winding 220.

It can be understood that three or more ventilation grooves 123 are evenly distributed in the circumferential direction of the shell assembly 100 to provide heat dissipation in a plurality of directions, thereby achieving a better heat dissipation effect.

It can be understood that as shown in FIG. 14, an inner cylinder 124 is arranged on the stator mounting portion 120. The inner cylinder 124 is located at an edge of the first end face 122. The inner cylinder 124 forms an inner wall of the secondary diffusing channel 102. A spacing is reserved between the inner cylinder 124 and the stator core 210. The spacing is a portion of the fluid channel 201. Part of the airflow flowing through the secondary diffusing channel 102 is conveyed through the spacing and the ventilation grooves 123 to contact the winding 220 and dissipate heat from the winding 220. Alternatively, as the air in the spacing and the ventilation grooves 123 is driven by the high-speed airflow in the secondary diffusing channel 102, the air in the space where the winding 220 is located flows accordingly to dissipate heat.

It can be understood that as shown in FIG. 14, an end of the secondary diffuser blade 130 facing away from the wind cover 600 in the axial direction of the shell assembly 100 is defined as a tail end. The tail end does not extend beyond the inner cylinder 124, i.e., the secondary diffusing channel 102 has a greater length than the secondary diffuser blade 130. With the block of the inner cylinder 124, the radial diffusion of the airflow flowing through the tail end is reduced, thereby improving the pressurization performance.

It can be understood that as shown in FIG. 14, the first end 211 is closer to the wind cover 600 than the tail end of the secondary diffuser blade 130, making the structure of the electric blower more compact and easier to be assembled into a vacuum cleaner. Alternatively, the tail end of the secondary diffuser blade 130 may be located between the first end 211 and the wind cover 600, such that the airflow passing through the tail end can contact with a larger surface of the stator core 210 to facilitate heat dissipation.

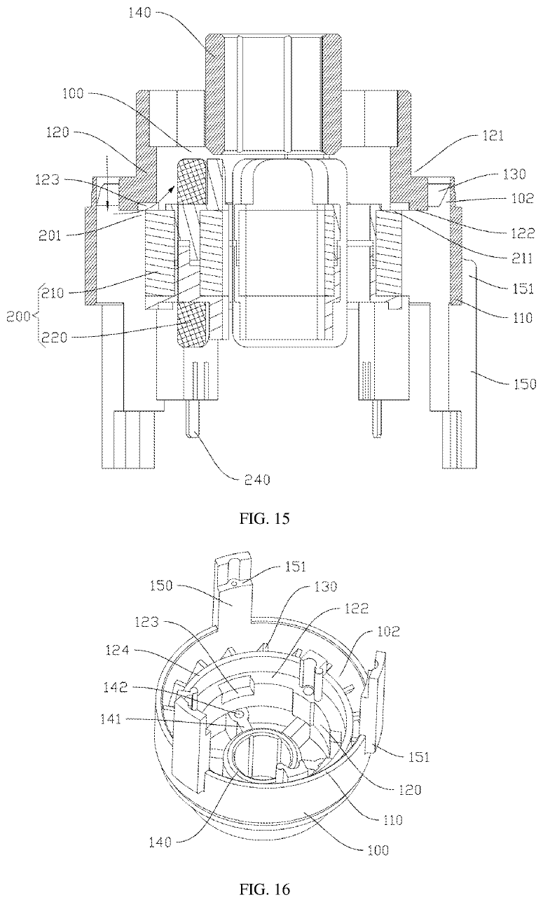

It can be understood that as shown in FIG. 15, the first end face 122 extends to the diffusing channel 101, and the tail ends of the secondary diffuser blades 130 are located between the first end 211 and the wind cover 600. Portion of the airflow passing through the tail ends flows along the first end face 122, and then flows through the ventilation grooves 123 to dissipate heat from the winding 220. Because the airflow has a high flow velocity, the heat dissipation effect is improved.

It can be understood that as shown in FIG. 18, the stator assembly 200 abuts against the first end face 122 of the stator mounting portion 120 through the first end 211 of the stator core 210, and the stator assembly 200 is fixedly mounted on the stator mounting portion 120 through a plurality of mounting portions 230. The mounting portions 230 are fixedly connected to the stator mounting portion 120 through fasteners (such as, screws) to facilitate assembly, disassembly, and maintenance.

Referring to FIG. 21, the electric blower according to some embodiments of the first aspect of the present disclosure is applied to a cleaning apparatus. A plurality of mounting legs 150 are circumferentially evenly distributed at an end of the cylindrical portion 110 facing away from the wind cover 600. Three mounting legs 150 can be provided. The following description is given using three mounting legs 150 as an example. The function of the mounting legs 150 is to cooperate with an assembly structure of the cleaning apparatus for assembly, to facilitate the fixing of the electric blower and the mounting of the electric blower into the cleaning apparatus, thereby simplifying the structure and shortening the assembly time.

When the electric blower operates, the rotor assembly 300 drives the rotary impeller 500 to rotate at a high speed. The rotary impeller 500 and the wind cover 600 cooperate to generate a high-speed airflow. The high-speed airflow passes through the diffusing channel 101. Under the action of the diffuser blades 410, the flow velocity of the airflow is reduced and the pressure is diffused, to generate a large suction force and meet usage requirements of the cleaning apparatus. The high-speed rotation of the rotary impeller 500 causes vibration of the electric blower, and the use of the mounting legs 150 in combination with the assembly structure of the cleaning apparatus can confine the electric blower and reduce the impact of vibration, thereby improving the reliability during use.

It can be understood that the mounting legs 150 and the cylindrical portion 110 are made an integral structure, which may be an injection molded plastic member or a metal member, as long as strength requirements can be met.

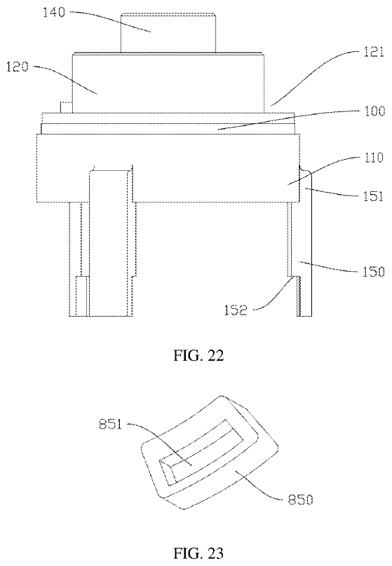

Referring to FIG. 22, it can be understood that in the radial direction of the shell assembly 100, the mounting leg 150 has a greater thickness than the cylindrical portion 110, an inner side of the mounting leg 150 is flush with the cylindrical portion 110, and an outer side of the mounting leg 150 protrudes out of an outer wall of the cylindrical portion 110. As such, the mounting legs 150 have higher structural strength and are more stable and reliable after being assembled into the cleaning apparatus.

Referring to FIG. 22, it can be understood that each mounting leg 150 is provided with a connecting portion 151. The connecting portion 151 is located at a root of the mounting leg 150 connected to the cylindrical portion 110. The connecting portion 151 extends in the axial direction of the shell assembly 100 and faces the wind cover 600. The connecting portions 151 are integrally connected to the outer wall of the cylindrical portion 110. The connecting portions 151 increase the stability of the connection between the mounting legs 150 and the cylindrical portion 110, and provide a supporting force to reduce the risk of bending and breaking of the mounting legs 150, thereby increasing the structural strength and improving the durability.

Referring to FIG. 20, it can be understood that the control board 700 is mounted through the mounting legs 150. The three mounting legs 150 surround the control board 700. A stepped surface 152 is provided in the middle of each mounting leg 150. The stepped surface 152 abuts against the control board 700, such that the stepped surface 152 is located on an inner side surface of the mounting leg 150. The control board 700 is mounted on the stepped surfaces 152 by fasteners (such as, screws) to facilitate assembly, disassembly, and maintenance. In addition, wiring terminals 240 of the stator assembly 200 extend to the control board 700 and are electrically connected to the control board 700 by soldering. The three mounting legs 150 stably support the control board 700 and can protect the control board 700 from collisions.

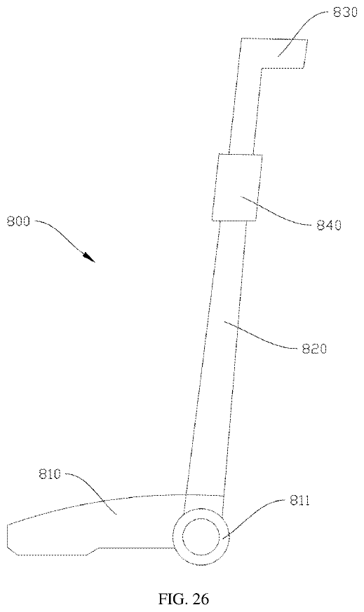

According to a second aspect of the present disclosure, an embodiment provides a cleaning apparatus. As shown in FIG. 26, the cleaning apparatus is, for example, a hand-held vacuum cleaner 800. The hand-held vacuum cleaner 800 includes a cleaning portion 810 at a lower end thereof, a connecting rod 820, and a handle 830. The cleaning portion 810 may be provided with a caster 811 for moving. The cleaning portion 810 is provided with a dust suction port. Two ends of the connecting rod 820 are connected to the cleaning portion 810 and the handle 830, respectively. The handle 830 is configured for a user to hold. The electric blower described above is mounted in the middle of the connecting rod 820. The electric blower is configured for operating to generate a suction force to suck dust through the dust suction port to achieve the purpose of cleaning.

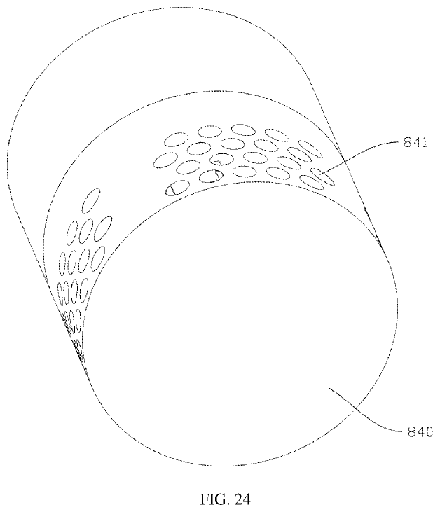

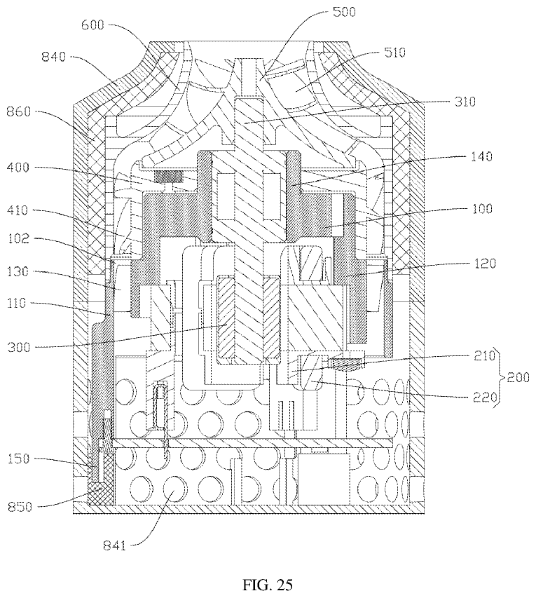

Referring to FIG. 24 and FIG. 25, it can be understood that the electric blower is assembled in the hand-held vacuum cleaner 800 through a mounting sleeve 840. The mounting sleeve 840 has an inner cavity for accommodating the electric blower. One end of the mounting sleeve 840 wraps the outer wall of the wind cover 600 to prevent the electric blower from coming out of the inner cavity. Another end of the mounting sleeve 840 is configured as a closed structure. A plurality of exhaust holes 841 are provided in a peripheral wall of the mounting sleeve 840 for the electric blower to exhaust air. Mounting pads 850 in one-to-one correspondence with the mounting legs 150 are arranged in the inner cavity. Referring to FIG. 23, each mounting pad 850 has an insertion hole 851. The mounting legs 150 are respectively inserted into the insertion holes 851 during assembly, to achieve accurate positioning. The mounting pads 850 provide a supporting force.

Referring to FIGS. 24 and 25, it can be understood that the mounting sleeve 840 consists of two halves. The two sleeve halves are removably or fixedly connected in the axial direction of the electric blower. The split-type mounting sleeve 840 facilitates the mounting of the electric blower into the inner cavity of the mounting sleeve 840 and the mounting of the mounting pads 850.

Referring to FIG. 25, it can be understood that a flexible cover 860 is arranged between the mounting sleeve 840 and the electric blower. The flexible cover 860 is sleeved over the outer wall of the wind cover 600 and abuts against an inner wall of the mounting sleeve 840. The flexible cover 860 is made of a flexible material (such as, rubber), and the mounting pad 850 is also made of a flexible material (such as, rubber). Considering that the electric blower experiences vibration during operation, the flexible cover 860 and the mounting pads 850 are used to absorb vibration and reduce noise, thereby improving the use experience of the hand-held vacuum cleaner 800.

It can be understood that the cleaning apparatus includes all the technical schemes of the electric blower and has all the technical effects of the electric blower, and the details will not be repeated herein.

The embodiments of the present disclosure have been described in detail above with reference to the accompanying drawings, but the present disclosure is not limited to the above embodiments, and various changes may be made within the knowledge of those having ordinary skills in the art without departing from the scope of the present disclosure.

What is claimed is:

1. An electric blower, applicable to a cleaning apparatus, the electric blower comprising:
a shell assembly, wherein a stator assembly and a rotor assembly are arranged inside the shell assembly;
a wind cover, connected to the shell assembly;
a rotary impeller, located inside the wind cover and connected to a rotating shaft of the rotor assembly; and
a diffuser, arranged at an end of the shell assembly facing the wind cover, and located between the rotary impeller and the shell assembly,
wherein a cylindrical portion is arranged on an outer wall of the shell assembly, a plurality of mounting legs are circumferentially distributed at an end of the cylindrical portion facing away from the wind cover, and the mounting legs are configured for fitting with an assembly structure of a cleaning apparatus.

2. The electric blower of claim 1, wherein in a radial direction of the shell assembly, the mounting legs protrude out of an outer wall of the cylindrical portion.

3. The electric blower of claim 2, wherein in an axial direction of the shell assembly, a connecting portion is arranged at a root of each of the mounting legs connected to the cylindrical portion, and the connecting portion extends to the wind cover and is connected to the outer wall of the cylindrical portion.

4. The electric blower of claim 2, wherein the cylindrical portion and the mounting leg are an integrally formed structure.

5. The electric blower of claim 4, wherein the cylindrical portion and the mounting legs are an integral plastic member or a metal member.

6. The electric blower of claim 3, wherein the cylindrical portion and the mounting leg are an integrally formed structure.

7. The electric blower of claim 6, wherein the cylindrical portion and the mounting legs are an integral plastic member or a metal member.

8. The electric blower of claim 1, further comprising a control board, wherein a stepped surface is provided on an inner side surface of each of the mounting legs facing a center of the shell assembly, the control board abuts against the stepped surface, and the control board is fixedly connected to the mounting legs by fasteners.

9. A cleaning apparatus comprising the electric blower of claim 1.

10. The cleaning apparatus of claim 9, further comprising a mounting sleeve,
wherein:
the electric blower is arranged in an inner cavity of the mounting sleeve;
an end of the mounting sleeve wraps an outer wall of the wind cover;
a plurality of exhaust holes are provided in a peripheral wall of another end of the mounting sleeve;
mounting pads are arranged inside the mounting sleeve; and
each of the mounting pads is provided with an insertion hole matching a corresponding mounting leg.

11. The cleaning apparatus of claim 10, wherein the mounting sleeve consists of two halves, and the two sleeve halves are removably connected in an axial direction of the electric blower.

12. The cleaning apparatus of claim 10, wherein a flexible cover is arranged on an inner wall of the mounting sleeve, and the flexible cover surrounds the wind cover and abuts against the outer wall of the wind cover.
